(19) United States
(12) Patent Application Publication
(10) Pub. No.: US 2006/0022791 A1
(43) Pub. Date: Feb. 2, 2006

(54) Terminal device for remote monitoring and control system

(75) Inventor: Yuichi Yoshimura, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 11/186,880

(22) Filed: Jul. 22, 2005

(30) Foreign Application Priority Data
Jul. 27, 2004 (JP) 2004-219311

(51) Int. Cl. G05B 23/02; G08C 19/16

(52) U.S. Cl. 340/3.1; 340/870.01

(57) ABSTRACT

Disclosed is a terminal for a remote monitoring and control system, which has both of functions of an input terminal device and an output terminal device, and can reduce space to be mounted, cost effectively manufactured and allow flexible system design and modification. A terminal circuit part has a determination function for determining whether a terminal module mounted to an applied part is an input module or an output module based on an identification signal transmitted from the mounted modules via the respective applied parts, an input terminal function for producing monitor data based on a signal from the applied part to which an input module is mounted, and an output terminal function for controlling a driver based on control data when a transmission signal containing address data corresponding to the applied part to which an output module is mounted is received by the a signal transceiver, and driving a relay in the output module by an output voltage of the driver.

This application claims benefit under 35 U.S.C. § 119 from Japanese Patent Application No. 2004-219311, filed on Jul. 27, 2004, the entire content of which is incorporated herein by reference.

### BACKGROUND OF THE INVENTION

1. Field of the Invention

The present invention relates to a terminal device for use in a remote monitoring and control system which performs remote monitoring and control with respect to loads such as lighting instrument.

2. Description of the Related Art

A conventional remote monitoring and control system has been provided as shown in FIG. 5.

This remote monitoring and control system includes a two-wire signal line 2, a transmission unit 3, an input terminal device 4 for monitoring the state of operation switches SW1 . . . , an input terminal device 4′ for receiving the state of a signal source SG, and an output terminal device for controlling a load 1 such as lighting instrument by a relay contact (not shown) as its basic elements, wherein the load 1 is connected to a power supply (not shown) via the relay contact (not shown) of a relay Ry controlled by the output terminal device 5. Reference numeral Tr denotes a transformer for driving the relay Ry in FIG. 5.

In the remote monitoring and control system ad described above, as the transmission unit 3 transmits a transmission signal Vs with a format shown in FIG. 6, data communication is performed between the terminal devices 4, 4′, and 5. The transmission signal Vs is a multi-polarity (±24V) time-division multiple signal being comprised of a start pulse ST representing the transmission start, a mode data MD representing a mode of a signal, an address data AD for identifying the terminal devices 4, 4′ and 5, a control data CD representing the control-content for controlling the load 1, an error correction symbol CS such as checksum data for detecting transmission error, and a return wait period WT for returning return signals by the terminal devices 4, 4′ and 5, and the data is transmitted by the pulse-width demodulation.

The terminal devices 4, 4′ and 5 receive the control data CD in the transmission signal Vs when the address in the address data AD in the transmission signal Vs which is received via the two-wire signal line 2 matches its own address which is preset, and returns a return signal as a current mode signal (signal transmitted by fragmenting the line interval of the signal line 2 by proper low impedance) in synchronization with a return wait period WT in the transmission signal Vs.

The input terminal device 4 or 4′ is directed to output an interrupt signal Vi shown in FIG. 6(a) as the current mode signal when any operation is given to the operation switch SW1 or there is any change in the state of the signal source SG in a period for receiving the start pulse ST of the transmission signal Vs transmitted in a routine time shown in FIG. 6(b). The transmission unit 3 includes a signal transmission means and an interrupt processing means. The transmission unit 3 permanently transmits the transmission signal Vs with an address AD of an object terminal device whose mode data MD is continuously monitored in a polling mode by a signal transmission means or a dummy address data. The interrupt processing means sequentially transmits the transmission signal Vs with a group address for use in identifying the input terminal device 4 or 4′ by a group and detects the input terminal device 4 or 4′ transmitted the interrupt signal Vi in case that the interrupt signal Vi, which is transmitted in response to the operations of the operation switch SW1 or change of the state of the signal source SG in synchronization with the start pulse ST of the transmission signal Vs of the polling mode, is received.

The input terminal device 4 or 4′ transmitted the interrupt signal Vi returns its own address as a return signal in the return wait period WT when its group address is accessed, then the transmission unit 3 which received the return signal detects the input terminal device 4 or 4′ transmitted the interrupt signal Vi by the received address data and transmits the transmission signal Vs accessing the input terminal device 4 or 4′, and then the input terminal device 4 or 4′ returns the operation data of the operation switch SW1 . . . or the state of the signal source SG as the monitor data by a return signal in the return wait period WT.

The transmission unit 3 produces control data CD with respect to an output terminal device 5 which is preset to correspond to the input terminal device 4 or 4′ based on the monitor data through a series of interruption processes as described above, and transmits the produced data by the transmission signal Vs along with an address of the output terminal device 5 by a time division multiple access method. The output terminal device 5 accessed by the transmission signal Vs drives and controls the relay Ry and turns on/off the load 1 by a relay contact.

As described above, the remote monitoring and control system can turn on/off the load 1 through a relay Ry by the output terminal device 5 mating with the input terminal device 4 or 4′ in the state of the operation switch SW1 of the input terminal device 4 or 4′ or the signal source SG.
Cited reference 1: Japanese Patent Laid-Open No. H10-98782 (paragraph 0009, FIG. 1)
Cited reference 2: Japanese Patent Laid-Open No. 2000-278777 (paragraph 0045-0048, FIG. 1)
Cited reference 3: Japanese Patent No. 3069368 (FIG. 1)

By the way, as the input terminal device 4′ for use in the remote monitoring and control system, a terminal device in contact with a dry contact (for example, cited reference 1) or a thermal sensor (for example, cited reference 2) as the signal source SG is provided. Meanwhile as the output terminal device 5, a terminal incorporating a remote control relay in its body (for example, cited reference 3) is provided. That is, terminal devices dedicated to respective roles are suggested, separately.

With reference to FIG. 5, in the output terminal device 5 having the relay Ry at the exterior thereof, spaces for the relay Ry and the terminal 5 should be respectively reserved. For example, as shown in FIG. 5, in case that the terminal device 5 with the relay Ry is arranged in a cabinet panel 6, the system is disadvantageous in an aspect of effective use of the limited space of the cabinet panel 6.

Further, for a point of view from a manufacturer, since the terminal devices should be separately manufactured, there is a disadvantage that the manufacturing cost is high. Further, in case that any terminal device is needed to be replaced with a new one having a new function due to the system modification, since the unnecessary terminal device should be separated from the system to mount the new terminal device, the conventional terminal device is disadvantageous in that the system modification cost is high.

### SUMMARY OF THE INVENTION

The present invention has been developed in order to solve and in light of the above drawbacks and other problems associated with the related art. A feature of the present invention is to provide a terminal device for use in a remote monitoring and control system, which is simultaneously serving as both of an input terminal device and an output terminal device, thereby capable of reducing system installation space and manufacturing cost, and allowing the system to be flexibly designed and modified. To achieve the object above, in accordance with a first feature of the present invention, there is provided a terminal device for use in a remote monitoring and control system which includes a terminal device and a transmission unit for connecting the terminal device by a signal line, transmitting a transmission signal containing address data calling the terminal device via a signal line, producing control data based on monitor data transmitted from the terminal device in a return wait period set by the transmission signal, and transmitting the address data calling a terminal device which is directed to match with the terminal device transmitted the monitor data and the produced control data by the transmission signal, the terminal device comprising: a plurality of applied parts to detachably mount an output module with a relay controlling a load or an input module receiving a signal from a signal source of an object to be monitored; a signal transceiver part for receiving the transmission signal and transmitting monitor data using a return signal in synchronization with a return wait period; an address setting device for setting addresses for use in identifying terminal devices or each respective applied parts in accordance with an external optical signal; and a terminal circuit part having a determination function for determining whether a terminal module mounted to the applied part is an input module or an output module based on an identification signal transmitted from the mounted modules via the respective applied parts, an input terminal function for producing monitor data based on the signal which is received by the input module from the corresponding applied part and transmitting the return signal through the signal transceiver, and an output terminal function for controlling the drivers installed to correspond to the applied parts based on the control data in the transmission signal when the transmission signal containing address data matching with set-address of the applied part, to which the output module is mounted, is received by the signal transceiver, and driving the relay in the output module by an output voltage of the driver.

In accordance with the first feature of the present invention, a terminal device serving as both of an input terminal device and an output terminal device can be constituted by simply mounting an input module or an output module to an applied part. A terminal device can be cost effectively manufactured by sharing the signal transceiver and the terminal circuit part in comparison with the case that an input terminal device and an output terminal device are separately constituted. A terminal device, which is capable of reducing the space needed to be installed when the terminal device is mounted on the cabinet panel with the limited space in comparison with the case that an input terminal device and an output terminal device are separately constituted, can be provided. A remote monitoring and control system can be flexibly designed and modified by using the terminal device in accordance with the first feature of the present invention, since the input and output terminal device is set by a terminal module, and is capable of reducing system modification cost by simply replacing a terminal module with a new one when the system configuration changes.

In accordance with a second feature of the present invention, an object to be mounted to the applied part is an input module with a dry contact as a signal source as in the first feature of the present invention.

In accordance with the second feature of the present invention, an input terminal device using the dray contact as the signal source can be simply constituted.

In accordance with a third feature of the present invention, the signal source is a thermal sensor as in the first feature of the present invention.

In accordance with the third feature of the present invention, a human body detection terminal unit can be simply constituted by using the thermal sensor.

### BRIEF DESCRIPTION OF THE DRAWINGS

The above aspects and features of the present invention will be more apparent by describing certain embodiments of the present invention with reference to the accompanying drawings, in which:

FIG. 1 is a circuital diagram of a terminal device in accordance with one embodiment of the present invention;

FIG. 2 illustrates exemplary uses of the terminal device in accordance with the one embodiment of the present invention, wherein (a) is a perspective rear view in which an input module is separated from a main body, (b) is a perspective front view in which an input module is separated from a main body, and (c) is a perspective front view in which on input module is attached to the main body;

FIG. 3 illustrates another exemplary uses of the terminal device in accordance with the one embodiment of the present invention, wherein (a) is a perspective rear view in which an output module is separated from a main body, (b) is a perspective front view in which an output module is separated from the main body, and (c) is a perspective front view in which four output modules are attached to the main body;

FIG. 4 illustrates a circuit diagram of a main part in accordance with the one embodiment of the present invention, wherein (a) is a view with an input module and (b) is a view with an output module;

FIG. 5 illustrates a constitution of a remote monitoring and control system using terminal devices in accordance with conventional arts; and

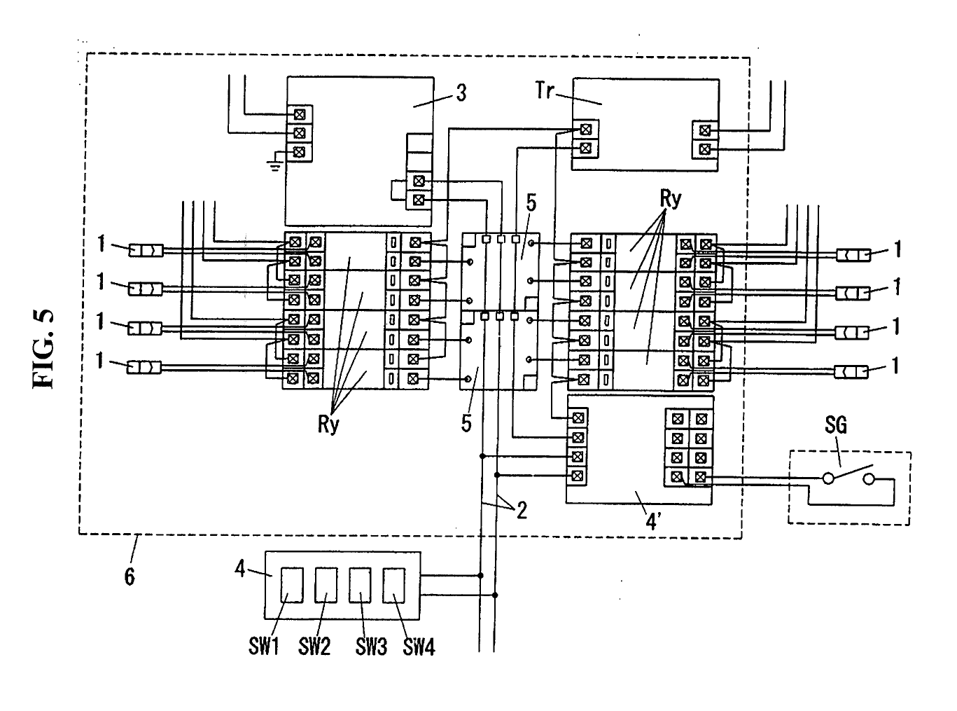

FIG. 6 is a diagram to explain a transmission signal for use in a remote monitoring and control system.

### DETAILED DESCRIPTION OF THE PREFERRED EMBODIMENTS

Certain embodiments of the present invention will be described in greater detail with reference to the accompanying drawings.

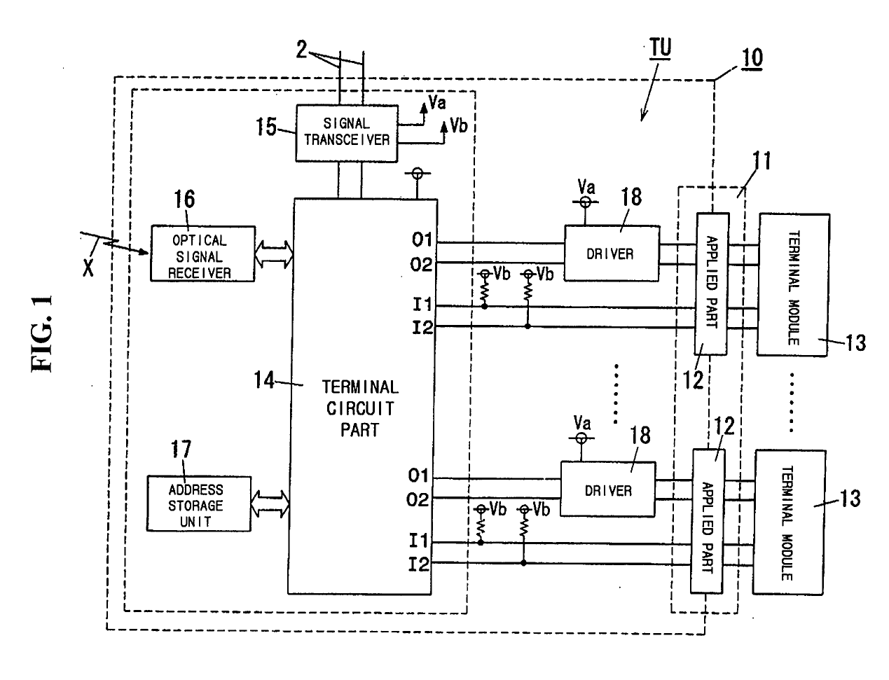

FIG. 1 illustrates a circuital diagram of one embodiment of the present invention, and a terminal device TU in accordance with one embodiment of the present invention includes a shared circuit block 10, and a plurality of external terminal modules 13 which are connected externally via applied parts 12 . . . provided in a applied unit 11 which will be described below to the shared circuit block 10. The terminal modules 13 includes an input module 13A for receiving an on/off signal of a dry contact or a state signal of a signal source and an output module 13B with a relay for controlling a load. By mounting both of the input and output modules 13A, 13B, a terminal device for both of input and output can be realized.

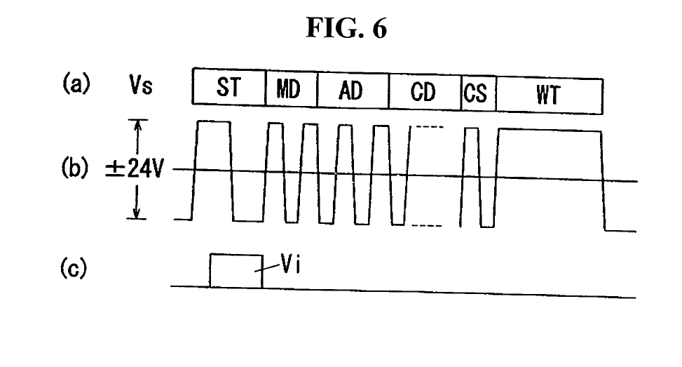

The shared circuit block 10 includes a terminal circuit part 14 realized by a micro computer for performing signal processing and control processing of the whole terminal device; a signal transceiver 15 connected to a signal line 2 and having a signal transmitting/receiving function for receiving a transmission signal Vs, which is shown in FIG. 6 and comprised of a multi-polarity base band, sending an address data AD and a control data CD contained in the transmission signal Vs to the terminal circuit part 14, and transmitting monitor data output from the terminal circuit part 14 as a return signal of a current mode over the signal line 2 in a return wait period WT set in the transmission signal Vs and a power supply function serving as a power supply by rectifying the multi-polarity transmission signal Vs to acquire direct current voltages Va and Vb and supplying them to the shared circuit block 10 as an operation power; an optical signal receiver 16 for receiving an address set-data from an external address setting device (not shown) via an optical signal X and sending it to the terminal circuit part 14; an address storage memory 17 formed of an electrically erasable programmed read only memory (EEPROM), for storing address data of the terminal device TU, which is set based on the address set-data received from the optical signal receiver 16 and erasing the stored address data under the control of the terminal circuit element 14; and drivers 18 associated with respective applied parts 12 for controlling polarities of voltages generated at output terminals based on the control signal output from output ports O1, O2.

The address setting device is comprised of the optical signal receiver 16, a set function of the terminal circuit part 14 and the address storage memory 17. The address setting device sets a unique address for each terminal device TU, for example, sets an address for each applied part 12 by selecting an address in an address range allocated to terminal devices for input and output depending on types of the terminal modules 13 to be mounted to the applied parts 12, thereby being capable of setting addresses matching with the types of the terminal modules 13 to be mounted to the applied part 12 for the applied parts 12.

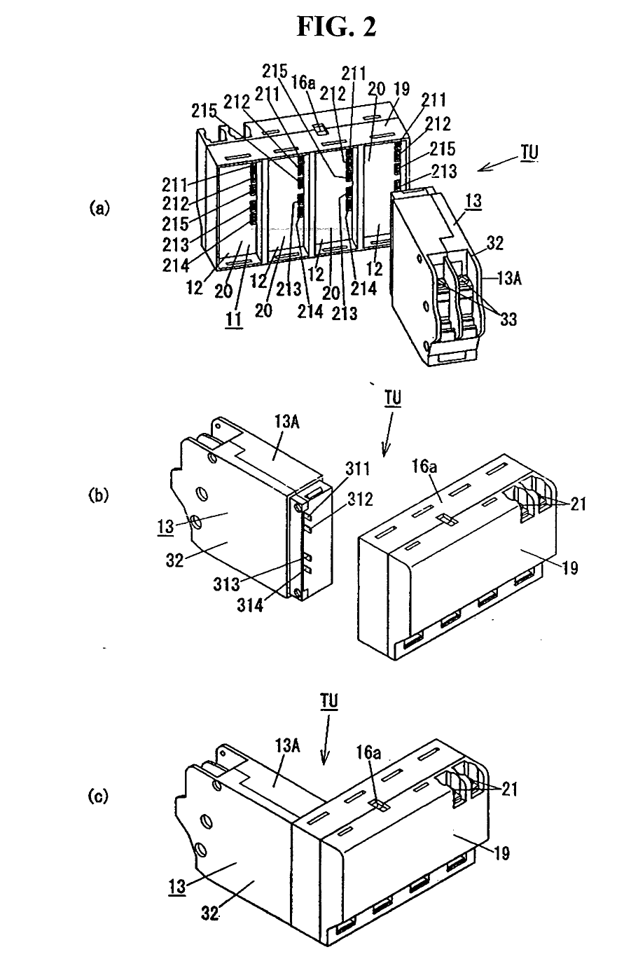

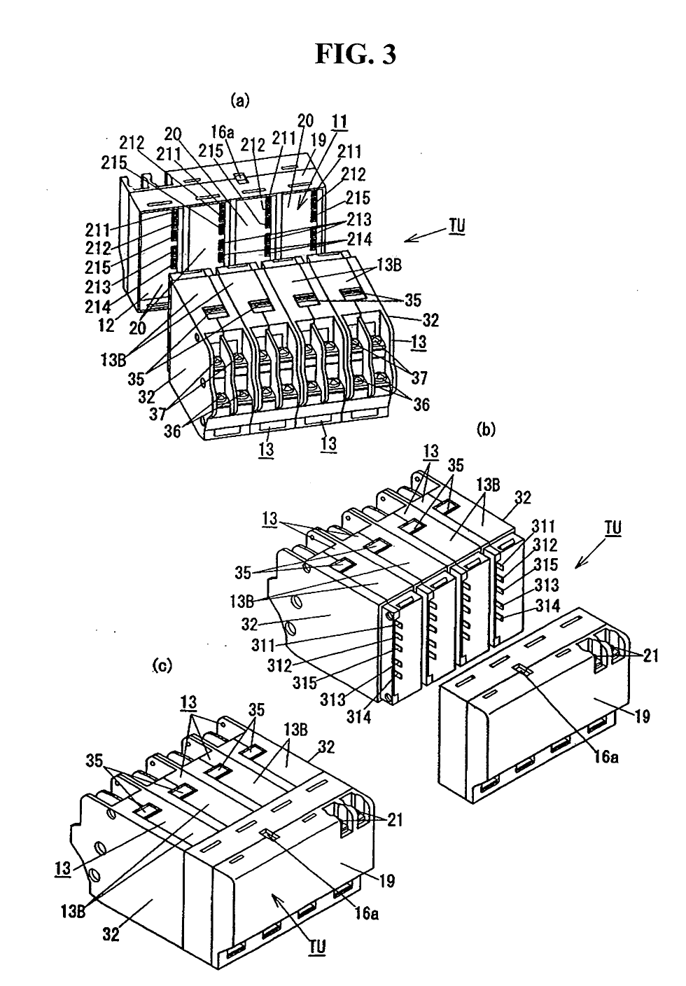

The main body 19 of the terminal device TU is formed of a synthesis resin molding, has an exterior of about rectangular parallelepiped shape as shown in FIG. 2A or FIG. 3A and has the applied unit 11 described above at the rear surface thereof. The applied unit 11 has four recessed flat sections 20 . . . formed by partition walls extending in the longitudinal direction, and five contact terminals 211 to 215 on either one side wall of each recessed flat section 20. The applied part 12 described above is comprised of one recessed flat section 20 and five contact terminals 211 to 215 and each terminal device TU has four applied parts 12, so that four terminal modules 13 can be mounted to one terminal device.

Meanwhile, the main body 19 has a pair of signal terminals 21 on the front surface thereof at an upper portion to be connected to a pair of the signal lines 2, as shown in FIG. 2B and in FIG. 3B. Further, the main body 19 has a light receiving part 16a of the optical signal receiver 16 on the top surface thereof at the center portion. The contact terminals 211, 212 are provided to output a voltage difference between a pair of output terminals of the driver 18 to the terminal module 13, and the contact terminal 213 is provided to connect an auxiliary contact provided at the terminal module side 13 or one end of the relay contact for outputting monitor information with monitor input ports I1 of the terminal circuit part 14, which matches with the applied parts 12, respectively.

Further, the contact terminal 214 is provided to connect the auxiliary contact at the terminal module side 13 or the other end of the relay contact with the ground voltage in the main body 19. The contact terminal 215 is provided to identify the types of the terminal modules 13 mounted in the applied parts 12 and is connected to an existence detection port 12 of the terminal circuit part 14.

The contact terminals 211 to 215 have a knife-edge structure in which ends of the knife-edges are stuck into the recessive flat sections 20, respectively, and plug blades of the contact terminals 311 to 315 of the terminal modules 13 are detachably inserted into the knife-edges.

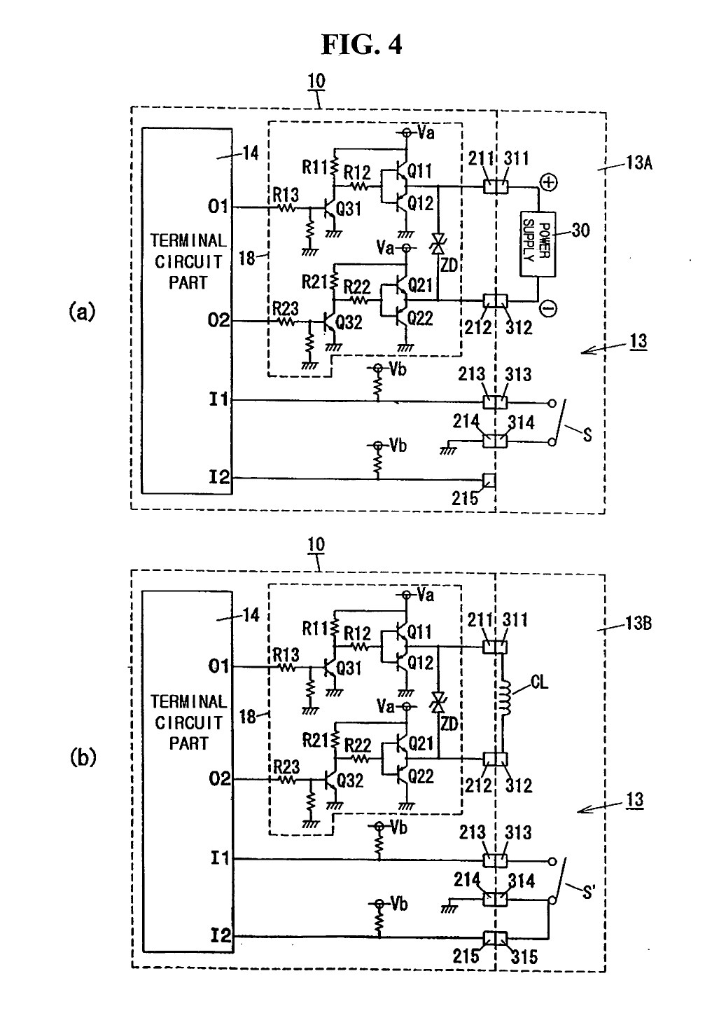

FIG. 4A and FIG. 4B illustrate detailed circuit diagrams of a main part of the present invention, in which a terminal module 13 is mounted to one applied part 12. As shown in FIG. 4A and FIG. 4B, the driver 18 comprises two sets of voltage polarity switch circuits, each set corresponding to the output ports O1, O2. Each voltage polarity switch circuit includes a series circuit formed of an NPN transistor Q11 or Q12 and a PNP transistor Q21 or Q22 connected between the DC voltage Va and the ground voltage, and further includes an NPN transistor Q31 or Q32 connected between the DC voltage Va and the ground voltage via a resistor R11 or R21. A base of the transistor Q11 or Q12, or a base of the transistor Q21 or Q22 is connected to a collector of the transistor Q31 or Q32 via a resistor R12 or R22, and a base of the transistor Q31 or Q32 is connected to the output port O1 or O2 via a resistor R13 or R23. An emitter of the transistor Q11 or Q12 of one of the voltage polarity switch circuit serves as an output terminal to be connected to the contact terminal 211, and an emitter of the transistor Q21 or Q22 of the other of the voltage polarity switch circuit serves as an output terminal to be connected to the contact terminal 212. Further, a constant-voltage device ZD is connected between both of the output terminals for clipping a voltage.

In case that the terminal circuit part 14 makes a control signal output from the output port O1 be “L” level, and a control signal output from the output port O2 be “H” level, the transistor Q31 is turned off, the transistor Q32 is turned on, the transistor Q11 is turned on, the transistor Q12 is turned off, the transistor Q21 is turned off, and the transistor Q22 is turned on, so that the DC voltage Va is connected to the contact terminal 211 via the transistor Q11 and the ground is connected to the contact terminal 212 via the transistor Q22.

On the contrary, in case that the terminal circuit part 14 makes the control signal output from the output port O1 be “H” level, and the control signal output from the output port O2 be “L” level, the transistor Q31 is turned on, the transistor Q32 is turned off, the transistor Q11 is turned off, the transistor Q12 is turned on, the transistor Q21 is turned on, and the transistor Q22 is turned off, so that the DC voltage Va is connected to the contact terminal 212 via the transistor Q21 and the ground is connected to the contact terminal 211 via the transistor Q12.

That is, the voltage polarity of the contact terminals 211 and 212 can be switched by setting the control signal output from the output ports O1, O2 to “H” level or “L” level.

Further, the monitor input port I1 of the terminal circuit part 14 is normally pulled up to the DC voltage Vb, receives a signal with “H” level when the ground contact terminal 214 connected to the ground and the monitor input contact terminal 213 connected to the monitor input port I1 are opened in the terminal module, and receives a signal with “L” level when the ground contact terminal 214 and the monitor input contact terminal 213 are connected in the terminal module.

The existence detection port I2 of the terminal circuit part 14 is normally pulled up to the DC voltage Vb, and receives a signal with “H” level or “L” level depending on whether the contact terminal 215 is connected to the ground in the terminal module 13 or not, and the terminal circuit part 14 determines whether the terminal module mounted to the applied part 14 is an input module 13A or an output module 13B by the received signal, i.e. identification signal.

With reference to FIG. 4A, the terminal module is an input module 13A which includes a dry contact or a relay contact S of relay operating depending on the state of the signal source, i.e. detection output, and a power supply 30 for driving a relay. The power supply 30 has a positive terminal connected to a power input contact terminal 311 in contact with the contact terminal 211 and a negative terminal connected to a power input contact terminal 312 in contact with the contact terminal 212. Further, one end of the relay contact S is connected to a signal contact terminal 313 in contact with the contact terminal 213, and the other end of the relay contact S is connected to the ground contact terminal 314 in contact with the contact terminal 214. Further, there is no contact terminal corresponding to the existence detection contract terminal 215.

The input module 13A has projected four plug blades corresponding to the terminals 311 to 314 at its front edges so as to be inserted into the applied part 212 of the main body 19 as shown in FIG. 2B. Therefore, the input module 13A constitutes an input terminal device by being connected to the shared circuit block 10 of the main body 19 as the plug blades thereof are inserted into the contact terminals 211 to 214 of the desired applied part 12.

Further, FIG. 2 illustrates an exemplary input terminal device using a thermal sensor or an external dry contact as the signal source. The main body 32 of the module has a terminal 33 to be connected to the signal source such as sensor and dry contact at its rear end portion.

In case that the input module 13A is mounted to any of the applied parts 12 of the main body 19, the terminal circuit part 14 in the main body 19 detects that the existence detection port 12 of the corresponding applied part 12 becomes “H” level, determines that the module 13 mounted to the corresponding applied part 12 is the input module 13A, allocates input terminal function to the applied part 12 based on the determination, performs a process to make the output port O1 output “L” level of the control signal and the output port O2 output “H” level of the control signal continuously, fixes polarities of the output voltages of the corresponding driver 18 by such process so as for the contact terminal 211 to be the positive polarity and the contact terminal 212 to be the negative polarity, and supplies a power with the DC voltage Va to the power supply block 30 of the input module 13A through the driver 18. Further, the terminal circuit part 14 sets address of the applied part 12 to be match with an input terminal device.

Meanwhile, with reference to FIG. 4B, the terminal module 13 shown in FIG. 4B is an output module 13B. The output module 13B embeds a single-turn latching relay in its body, and turns on/off a load at its main contact (not shown). The latching relay has an excite coil CL with two ends, an end being connected to the power input contact terminal 311 in contact with the contact terminal 211 and the other end being connected to the power input contact terminal 312 in contact with the contact terminal 212. In the output module 13B, an end of the auxiliary contact S′ representing the state of operation status of the main contact and operating depending on the operation of the main contact is connected the signal contact terminal 313 in contact with the contact terminal 213 and the other end of the auxiliary contact S′ is connected to the ground contact terminal 314 in contact with the contact terminal 214. The output module 13B further includes a contact terminal 315 corresponding to the contact terminal 215. The contact terminal 315 is in contact with the contact terminal 314 in the module.

With reference to FIG. 3B, the output module 13B has projected five plug blades corresponding to the contact terminals 311 to 315 at ends of the module main body 32 to be inserted and received into the applied part 12, and constitutes an output terminal device by being connected to the shared circuit block 10 of the main body 19 as the plug blades are inserted into and comes into contact with the contact terminals 211 to 215 of the desired applied part 12. Further, the module main body 34 exposes an operation part of a manual operation handle for inverting the states of the embedded latching relay in manual through the top surface thereof. Further, the module main body 34 has a pair of load contact terminals 36 to be connected to a series circuit of the load and the power supply via the main contact and a pair of transmission wire terminals 37 on the rear end portion thereof.

By the way, the lateral width of the main body 19 is determined to be 4P to meet the cabinet panel size agreement. In case that the input module 13A or the output module 13B are mounted to the applied part 12 as shown in FIG. 2C and FIG. 3C, the size from the front end to the rear end of the module main body 32 is determined to meet the cabinet panel size agreement. When the output module 13B is mounted, the terminal circuit part 14 of the shared circuit block 10 determines that the mounted module in the applied part 12 is the output module 13B if the existence detection port I2 of the corresponding applied part 12 has “L” level, and allocates the output terminal function producing a control signal to be output from the output ports O1, O2 based on the control data, which is transmitted to the address set by the transmission unit, to the applied part 12. At this time, the address of the applied part 12 is set to the predetermined address matching with an output terminal device.

In FIG. 2 and FIG. 3, the same type of terminal modules 13 are mounted but different types of terminal modules, the input module 13A and the output module 13B, can be mounted to the respective applied part 12 at the same time. At this time, the terminal circuit part 14 of the shared circuit block 10 is directed to set a mode in which different terminal functions are allocated to the respective applied parts 12 depending on the types of the mounted terminal modules 13, so that the applied parts 12 can operate according to the allocated functions, respectively.

Next, the operation of a remote monitoring and control system, to which a terminal device in accordance with the present embodiment is connected, will be described.

When the transmission signal Vs containing address data AD corresponding to the current set-address is received by the signal transceiver 15, the terminal circuit part 14 of the terminal device TU receives the control data CD in the transmission signal Vs, produces a control signal with respect to the driver 18 connected to the applied part 12 corresponding to the address, and outputs the control signals through the output ports O1, O2. Here, the terminal circuit part 14 performs the signal processing as the output terminal function mode in which the terminal circuit part 14 generates a control signals for setting polarities of the output voltages of the contact terminals 211, 212 and outputs them through the output ports O1, O2 to invert the states of the main contacts of the latching relay installed in the output module 13B mounted to the applied part 12 to match with the states of the control data CD. The terminal circuit part 14 returns the monitor data corresponding to the operation states of the latching relay, which are received by the inversion-operation of the auxiliary contact S′ as the return signal in the return wait period WT.

When the state of the relay contact S of the input module 13A mounted to one of the applied parts 12 is inverted, the terminal circuit part 14 performs the input terminal function operation mode, and transmits information of the contact to the transmission unit 3 as the monitor data after performing the interrupt processing as the conventional input terminal did.

As described above, the present invention is advantageous in that the input terminal device and the output terminal device can be co positively constituted by the terminal modules 13 to be mounted to the respective applied parts 12 since the signal transceiver 15, the terminal circuit part 14, the optical signal receiver 16, the address storage memory 17, and the driver 18 are included in the shared circuit block 10. In accordance with the present invention, a terminal device serving as both of an input terminal device and an output terminal device can be constituted by simply mounting an input module or an output module to an applied part.

In accordance with the present invention, a terminal device can be cost effectively manufactured by sharing the signal transceiver and the terminal circuit part in comparison with the case that an input terminal device and an output terminal device are separately constituted.

In accordance with the present invention, a terminal device, which is capable of reducing the space needed to be installed when the terminal device is mounted on the cabinet panel with the limited space in comparison with the case that an input terminal device and an output terminal device are separately constituted, can be provided.

In accordance with the present invention, a remote monitoring and control system can be flexibly designed and modified by using a terminal device in accordance with the present invention, since the input and output terminal device is set by a terminal module, and is capable of reducing system modification cost by simply replacing a terminal module with a new one when the system configuration changes.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A terminal device for a remote monitoring and control system which includes a terminal device and a transmission unit for contacting the terminal device to a signal line, transmitting a transmission signal containing address data calling the terminal device via a signal line, producing control data based on monitor data transmitted from the terminal device in a return wait period set by the transmission signal, and transmitting the address data calling a terminal device which is directed to match with the terminal device transmitted the monitor data and the produced control data by the transmission signal, the terminal device comprising:
a plurality of applied parts to detachably mount an output module with a relay controlling a load or an input module receiving a signal from a signal source of an object to be monitored;
a signal transceiver part for receiving the transmission signal and transmitting monitor data using a return signal in synchronization with a return wait period;
an address setting device for setting addresses for use in identifying terminal devices or respective applied parts; and
a terminal circuit part having a determination function for determining whether a terminal module mounted to the applied part is an input module or an output module based on an identification signal transmitted from the mounted modules via the respective applied parts, an input terminal function for producing monitor data based on the signal which is received by the input module from the corresponding applied part and transmitting the return signal through the signal transceiver, and an output terminal function for controlling the drivers installed to correspond to the applied parts based on the control data in the transmission signal when the transmission signal containing address data matching with set-address of the applied part, to which the output module is mounted, is received by the signal transceiver, and driving the relay in the output module by an output voltage of the driver.

2. The terminal device for a remote monitoring and control system as claimed in claim 1, wherein an object to be mounted to the applied part is an input module with a dry contact as the signal source.

3. The terminal device for a remote monitoring and control system as claimed in claim 1, wherein the signal source is a thermal sensor.
